(19) United States
(12) Patent Application Publication
(10) Pub. No.: US 2025/0274207 A1
(43) Pub. Date: Aug. 28, 2025

(54) LOCAL TELEVISION INTEGRATION INTO OVER-THE-TOP (OTT) DEVICES AND SERVICES

(71) Applicant: DISH Network L.L.C., Englewood, CO (US)

(72) Inventor: Samuel Eber, Denver, CO (US)

(21) Appl. No.: 19/061,623

(22) Filed: Feb. 24, 2025

Related U.S. Application Data
(60) Provisional application No. 63/556,691, filed on Feb. 22, 2024.

(51) Int. Cl. H04H 20/61; H04N 21/4363

(52) U.S. Cl. CPC H04H 20/61; H04N 21/43637

(57) ABSTRACT

Techniques for integrating local television content into over-the-top (OTT) devices and services are presented herein. In some techniques, a television media broadcaster comprises a satellite antenna interface for receiving RF signals corresponding to a plurality of television channels including regional broadcast channels, an RF tuner for demodulating the RF signals into digital signals, and a communication interface to transmit the digital signals to a remote device for presentation on a display. In response to receiving a tuning request from the remote device for live media content for a regional channel, the RF tuner is tuned to a frequency corresponding to the channel, and a digital signal representing the live content is received and transmitted to the remote device for presentation.

### CROSS REFERENCE TO RELATED APPLICATIONS

This application claims priority to U.S. Provisional Patent Application No. 63/556,691, filed on Feb. 22, 2024, the disclosure of which is incorporated by reference in its entirety for all purposes.

### BACKGROUND OF THE INVENTION

While people spend a great deal of time watching television programming and other forms of audio-visual (A/V) content, the devices and services used to consume such content are increasingly reliant on digital streaming over the internet. Over-the-top (OTT) services and devices allow viewers to consume video, audio, and other media content delivered by an ever increasing number of providers, on virtually any device with a screen, and from almost anywhere with an internet connection. However, each individual service is typically limited to content owned or licensed by the service provider and does not include content from regional broadcasters. It would therefore be beneficial to enable people to enjoy local television programming through the same OTT devices and services.

This ability would enable several desirable applications. For example, a user might want to access local television programming from a personal computer (desktop as well as notebook computers) or other computing devices around the home via the user's local network in the home. Since cable, satellite, and other sources of television content typically enter the house at a few discrete locations, allowing access to the content over a home network gives the user more freedom to enjoy the content throughout the home. Another possible application would be to enable a user to access local television programming from any number of remote networks where a broadband connection is available to the user (e.g., at an airport, at work, at school, in a hotel, in a cafe, at an acquaintance's house). Yet another application would be to enable a user to access local television programming from a mobile phone or other computing devices that can be connected to a wide area network.

### BRIEF SUMMARY OF THE INVENTION

Various embodiments are described related to integrating local television into OTT devices and services. In some embodiments, a television media broadcaster is described. The broadcaster may comprise a satellite antenna interface for receiving a radio frequency (RF) signal from a satellite antenna. The RF signal may comprise a plurality of frequencies corresponding to a plurality of television channels, and the plurality of frequencies may comprise a subset of frequencies that correspond to regional broadcast television channels. The broadcaster may further comprise an RF tuner coupled to the satellite antenna interface. The RF tuner may be configured to filter the RF signal to the subset of frequencies and demodulate the filtered frequencies into digital signals. The broadcaster may further comprise a communication interface configured to transmit the digital signals to a remote device for presentation on a display. The broadcaster may further comprise a memory storing a set of instructions. The broadcaster may further comprise a processor coupled to the RF tuner, the communication interface, and the memory, the processor being configured to execute the set of instructions to receive, via the communication interface, a tuning request from the remote device for live media content from a first regional broadcast television channel. The processor may be further configured to tune the RF tuner to a first frequency of the subset of frequencies that corresponds to the first regional broadcast television channel. The processor may be further configured to receive, in response to tuning the RF tuner, a digital signal from the RF tuner representing the live media content transmitted from the first regional broadcast television channel. The processor may be further configured to transmit, via the communication interface, the digital signal to the remote device for presentation on the display.

In some embodiments, the communication interface comprises a network adaptor, the request from the remote device comprises a unique address for the remote device, and transmitting the digital signal to the remote device comprises transmitting the digital signal to the unique address for the remote device over a network. In some embodiments, the network is a local area network. In some embodiments, the network comprises a wide area network. In some embodiments, the broadcast further comprises a wireless network antenna coupled to the network adaptor. In some embodiments, the broadcast further comprises a wired communication port coupled to the communication interface and configured to receive a wired connection to the remote device. In some embodiments, the wired communication port comprises a universal serial bus port. In some embodiments, the wired communication port comprises a coaxial cable port.

In some embodiments, the RF signal further comprises a video-on-demand (VOD) frequency and the processor is further configured to execute the set of instructions to: receive a recording request for recorded media content from a satellite based content provider; tune the RF tuner to the VOD frequency; and receive, in response to tuning the RF tuner to the VOD frequency, a second digital signal representing the recorded media content transmitted from the satellite based content provider. In some embodiments, the processor is further configured to execute the set of instructions to: store the recorded media content from the second digital signal in the memory; receive, via the communication interface, a playback request from the remote device for the recorded media content; and transmit the recorded media content from the memory as a third digital signal to the remote device for presentation on the display.

In some embodiments, the processor is further configured to execute the set of instructions to: transmit, via the communication interface, the second digital signal to the remote device for storage by the remote device. In some embodiments, the RF tuner is a first RF tuner, the television media broadcaster further comprises a second RF tuner coupled to the satellite antenna interface, and the processor is further configured to execute the set of instructions to: receive, via the communication interface, a second tuning request from a second remote device for second live media content from a second regional broadcast television channel; determine that the first RF tuner is allocated to the first frequency; tune the second RF tuner to a second frequency of the subset of frequencies that corresponds to the second regional broadcast television channel; receive a second digital signal from the second RF tuner representing the second live media content; and transmit, via the communication interface, the second digital signal to the second remote device while concurrently transmitting the digital signal from the first RF tuner to the remote device.

In some embodiments, the processor is further configured to execute the set of instructions to: receive, via the communication interface, an indication of a geographic region within which the television media broadcaster is located; and determine, based on the indication of the geographic region, the subset of frequencies that correspond to the regional broadcast television channels for the geographic region. In some embodiments, the processor is further configured to execute the set of instructions to: receive, via the communication interface, user account information; transmit, via the communication interface, an authentication request to a satellite service provider server system, wherein the authentication request comprises the user account information; and receive, via the communication interface, an authentication response from the satellite service provider server system, wherein the authentication request comprises the subset of frequencies that correspond to the regional broadcast television channels.

In some embodiments, a method of facilitating television media content in a local network is described. The method may comprise receiving, at a satellite antenna interface of a television media receiver, an RF signal from a satellite antenna. The RF signal may comprise a plurality of frequencies corresponding to a plurality of television channels, and the plurality of frequencies may comprise a subset of frequencies that correspond to regional broadcast television channels. The method may further comprise receiving, via a communication interface of the television media receiver, a tuning request from a remote device for live media content from a first regional broadcast television channel. The method may further comprise tuning an RF tuner of the television media receiver to a first frequency of a subset of frequencies that corresponds to the first regional broadcast television channel. The RF tuner may be coupled to the satellite antenna interface and be configured to filter the RF signal to the subset of frequencies and demodulate the filtered frequencies into digital signals. The method may further comprise receiving, in response to tuning the RF tuner, a digital signal from the RF tuner representing the live media content transmitted from the first regional broadcast television channel. The method may further comprise transmitting, via the communication interface, the digital signal to the remote device for presentation on a display.

### BRIEF DESCRIPTION OF THE DRAWINGS

FIG. 1 illustrates an embodiment of an integrated over-the-top (OTT) and satellite television content delivery system.

FIG. 2 illustrates an embodiment of an integrated OTT and satellite television receiver system.

FIG. 3 illustrates an embodiment of a method for integrating satellite based television content and OTT services.

FIG. 4 illustrates a system for receiving and displaying content from satellite sources and streaming providers, according to certain embodiments.

### DETAILED DESCRIPTION OF THE INVENTION

Various embodiments according to the present disclosure may provide for local television channel integration into over-the-top (OTT) devices and services using satellite television receivers. Over-the-top (OTT) services and devices allow viewers to consume video, audio, and other media content delivered by an ever increasing number of providers, on virtually any device with a screen, and from almost anywhere with an internet connection. However, each individual service is typically limited to content owned or licensed by the service provider and does not include local live programming content from regional broadcast affiliates.

While local channels are available through other means, such as through specific OTT services, over-the-air broadcasting, and cable or satellite television subscriptions, these solutions are often costly or require complex integrations with over-the-air antennas. In addition, these solutions typically require user to change between video inputs on a television, meaning that users must navigate away from their preferred OTT applications or OTT device inputs to view the available content on local television channels.

Embodiments described herein address these and other technological challenges by allowing local television channels to be directly and seamlessly integrated into OTT devices and applications using satellite television receivers. For example, a satellite television receiver may be used to tune to a subset of the channels provided by a satellite television network. The satellite television receiver may then transmit the digital data representing the live programming from a regional broadcast television channel to an OTT device on the same network.

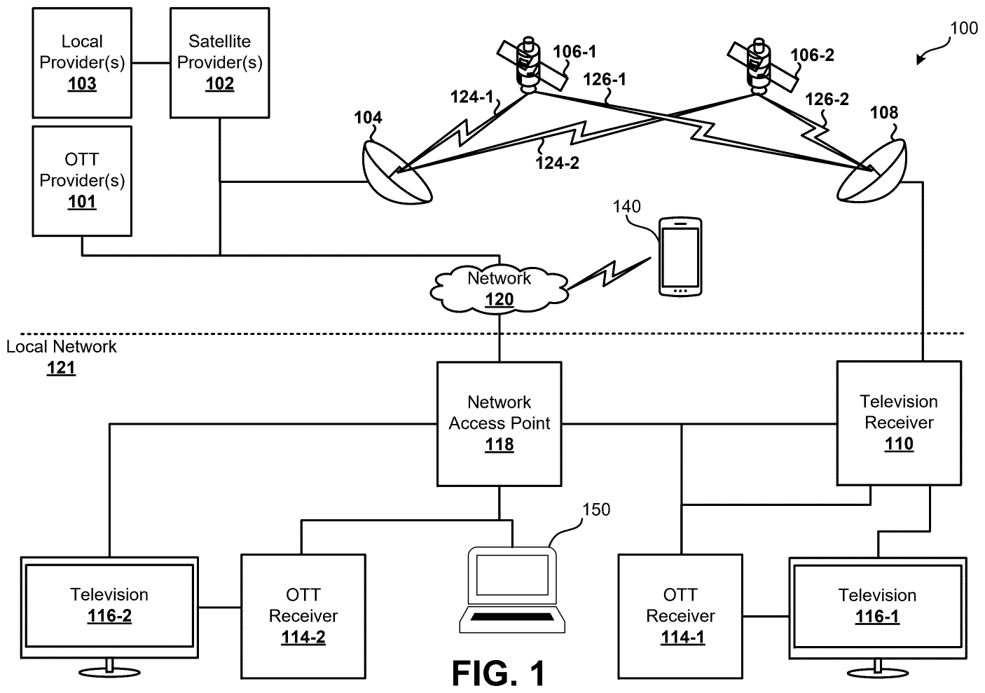

Further detail regarding the integration of local television channels in OTT devices and services is provided in relation to the figures. FIG. 1 illustrates an embodiment of an integrated over-the-top (OTT) and satellite based television content system. For brevity, system 100 is depicted in a simplified and conceptual form and may generally include more or fewer systems, devices, networks, and/or other components as desired. Further, the number and type of features or elements incorporated within system 100 may or may not be implementation-specific, and at least some of the aspects of system 100 may be similar to a cable television distribution system, an IPTV (Internet Protocol Television) content distribution system, and/or any other type of media or content distribution system.

System 100 may also include at least one network 120 that may facilitate bi-directional communication for data transfer between devices connected to network access point 118 and OTT provider(s) 101 and/or satellite provider(s) 102. Network 120 is intended to represent any number of terrestrial and/or non-terrestrial network features or elements. For example, network 120 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular network, or any other type of communication network within which data may be transferred between and among respective components of the system 100.

System 100 may also include at least one local network 121 that establishes a bi-directional communication path for data transfer between and among television receiver 110, network access point 112, OTT receivers 114, televisions 116, mobile device 140, and personal computer 150. Local network 121 may correspond to a home or business computing environment. Television receiver 110, together with OTT receivers 114 and televisions 116, may each be incorporated within or form at least a portion of a particular home or business computing network.

Television receiver 110 and OTT receivers 114 may correspond to television receivers and/or television converters, such as a set-top box (STB) for example, or smart TV content receivers. Television receiver 110 may be a streaming television receiver, configured to receive and display signals (e.g., streaming media content) on-demand and/or at or near real-time. In another example, television receiver 110 and OTT receivers 114 may exhibit functionality integrated as part of or into a television; a DVR (Digital Video Recorder); a computer, such as a tablet computing device; or any other computing system or device, as well as variations thereof. Further, television receiver 110 may be able to communicate with other devices in accordance with various communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection). For example, as disclosed further herein, one or more of the various elements or components of the at least one local network 121 may communicate using TCP/IP using one or more wireless techniques, such as Wi-Fi; or wired techniques, such as Ethernet or MoCA® (Multimedia over Coax Alliance). Still other embodiments are possible.

In practice, satellites 106 may each receive uplink signals 124 from satellite uplink 104. In this example, each of uplink signals 124 may contain one or more transponder streams of particular data or content, such as one or more particular television channels, as supplied by satellite provider(s) 102 and/or local provider(s) 103. For example, each of the respective uplink signals 124 may contain various media content such as encoded HD (High Definition) television channels, SD (Standard Definition) television channels, regional broadcast channels from local provider(s) 103, on-demand programming, programming information, and/or any other content in the form of at least one transponder stream, in accordance with an allotted carrier frequency and bandwidth. In this example, different media content may be carried using different versions of satellites 106.

Satellites 106 may further relay uplink signals 124 to satellite dish 108 as downlink signals 126. Similar to uplink signals 124, each of downlink signals 126 may contain one or more transponder streams of particular data or content, such as various encoded and/or at least partially electronically scrambled television channels and/or on-demand programming, in accordance with an allotted carrier frequency and bandwidth. Downlink signals 126, however, may not necessarily contain the same or similar content as a corresponding one of uplink signals 124. For example, uplink signal 124-1 may include a first transponder stream containing at least a first group or grouping of television channels, and downlink signal 126-1 may include a second transponder stream containing at least a second, different group or grouping of television channels. In other examples, the first and second group of television channels may have one or more television channels in common. In sum, there may be varying degrees of correlation between uplink signals 124 and downlink signals 126, both in terms of content and underlying characteristics. Further, satellite television signals may be different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO®, CBS®, and/or ESPN®.

In some embodiments, downlink signals 126 contain one or more transponder streams corresponding to over-the-air broadcast television channels provided by local provider(s) 103. Local provider(s) 103 may correspond to regional broadcast affiliates, or simply affiliates, that are local television stations affiliated with a larger network, typically a national or regional broadcast network. Local provider(s) 103 may control the rights to the network's programming within a specific geographical region. Transponder streams corresponding to regional broadcast television channels may have little or no encoding or encryption compared to transponder streams for other television channels and media streams. For example, such transponder streams may be transmitted in the clear, using open broadcasting standards like Advanced Television Systems Committee (ATSC) or Digital Video Broadcasting (DVB). In some embodiments, the groupings of downlink signals 126 include difference combinations of transponder streams based on the unique broadcast television channels for individual regions.

Satellite dish 108 may be provided to receive television channels (e.g., on a subscription basis) provided by satellite provider(s) 102, satellite uplink 104, and/or satellites 106. For example, satellite dish 108 may be receive particular transponder streams, or downlink signals 126, from one or more of satellites 106. As another example, satellite dish 108 may provide a plurality of television channel frequencies to a television frequency tuner of television receiver 110. Additionally, television receiver 110, which is communicatively coupled to satellite dish 108, may subsequently select via a tuner, decode, and relay particular transponder streams to television 116-1 for display thereon. For example, satellite dish 108 and television receiver 110 may, respectively, receive, decode, and relay at least one television channel to television 116-1. As another example, television receiver 110 may tune a television frequency tuner to a television channel frequency of a plurality of television channel frequencies received by satellite dish 108. Programming or content associated with the channel may generally be presented live, or from a recording as previously stored on, by, or at television receiver 110. Here, the channel may be output to television 116-1 in accordance with the HDMI/HDCP content protection technologies. However, other embodiments are possible. For example, the channel may be output to television 116-1 in accordance with the MoCA® (Multimedia over Coax Alliance) home entertainment networking standard. As another example, the channel may be output to television 116-1 in accordance with the Transmission Control Protocol (TCP) and/or Internet Protocol (IP) via network access point 118 over local network 121. In yet another example, the channel may be output to television 116-1 via a wired network connection over a private network containing television 116-1 and television receiver 110.

Further, television receiver 110 may select via a tuner, decode, and relay particular transponder streams to one or both of OTT receivers 114 which may in turn relay particular transponder streams to a corresponding television of televisions 116 for display thereon. For example, satellite dish 108 and television receiver 110 may, respectively, receive, decode, and relay at least one television channel to television 116-1 by way of OTT television receiver 114-1. Additionally, or alternatively, television receiver 110 may select via a tuner, decode, and relay particular transponder streams directly to televisions 116, personal computer 150, and/or mobile device 140 for display thereon. Similar to the above-example, television channels may be presented live, or from a recording as previously stored on television receiver 110, and may be output to television 116-1 by way of OTT television receiver 114-1 in accordance with a particular content protection technology and/or networking standard.

Relaying transponder streams and/or digital content from television receiver 110 to televisions 116 via OTT receivers 114 may include transmission via wireless communication. For example, the at least one local network 121 may include a private content network. Television receiver 110 may then transmit digital content to OTT receivers 114 via the private content network. Additionally, or alternatively, relaying transponder streams and/or digital content from television receiver 110 to televisions 116 via OTT receivers 114 may include transmission via one or more wired connections. For example, television receiver 110 may be connected to OTT receivers 114 and/or televisions 116 via a networking cable, such as CAT-5, a coaxial cable, a universal serial bus (USB) cable, and the like.

In some embodiments, OTT receivers 114, televisions 116, personal computer 150, and/or mobile device 140 execute a client software application that includes a user interface for integrating live television content from television receiver 110 with the media content provided by OTT provider(s) 101. In some embodiments, the client functionality is provided by a Web site and is accessible by OTT receivers 114, televisions 116, personal computer 150, and/or mobile device 140 via a Web browser. When any of the devices wish to connect to a stream of television receiver 110 using the client application or via a Web browser interface, it may specify an IP address associated with television receiver 110 to access and pull the media stream from television receiver 110. This action sends a request to television receiver 110, and the request travels across local network 121 and/or network 120 (e.g., the public Internet) to television receiver 110.

OTT receivers 114, televisions 116, mobile device 140, and/or personal computer 150 may receive digital content from OTT provider(s) 101 via network 120. For example, while television receiver 110 may receive satellite television channels via satellite dish 108 and provide them to OTT receivers 114, OTT receivers 114 may also access network 120 via network access point 118, as described below, to stream digital content from OTT provider(s) 101, such as Netflix®, Spotify®, Google®, YouTube®, Disney®, Hulu®, Peacock®, etc. and relay the digital content to televisions 116 for display thereon. While described as streaming content, OTT receivers 114 may also transmit, receive, or otherwise have access to, other forms of data such as documents, databases, websites, email, search engine results, digital assistant interfaces, and the like. As described above, while OTT provider(s) may enable access to a wide collection of movies and television shows, whether pre-recorded or live streamed, they often do not include access to live programming from regional and/or local broadcast television channels.

OTT receivers 114, televisions 116, mobile device 140, and/or personal computer 150 may access content from OTT provider(s) 101 via one or more web-based applications. In some embodiments, such web-based applications may include user interfaces that enable a user to access and view live programming provided by regional broadcast television channels via television receiver 110 from within the web-based application. Additionally, or alternatively, OTT receivers 114 may provide one or more user interfaces that enable a user to integrate television receiver 110 as a television content input for OTT receivers 114, which may then be added via a user interface of a web-based application. For example, such user interfaces may enable a user to provide identifying information for television receiver 110, such as make and model information, network address information, user account information, and the like. In response, the web-based applications, and/or OTT receivers 114 may initiate a connection with television receiver 110 via local network 121. Subsequently, when television receiver 110 provides media content to OTT receivers 114 via local network 121, the media content may be displayed within the web-based applications of OTT provider(s) 101.

Network access point 118 may function similar to a wireless router. For example, network access point 118 may receive digital communication from television receiver 110 and route the digital communication to an intended recipient of OTT receivers 114, televisions 116, personal computer 150, and mobile device 140. Network access point 118 may receive the digital communication via a wired connection from television receiver 110, such as via an Ethernet or MoCA® connection. Network access point 118 may then transmit the digital communication to the appropriate recipient via a wireless communication standard, such as Wi-Fi, Bluetooth®, ZigBee®, or the like. Additionally, network access point 118 may receive wireless communication from any of OTT receivers 114, televisions 116, personal computer 150, and mobile device 140 and relay the communication to television receiver 110 via a wired or wireless connection. For example, OTT receiver 114-2 may transmit a request to television receiver 110 via network access point 118 for live television media content corresponding to one of the transponder streams.

As described further below, the at least one local network 121 may include one or more general networks or general purpose networks. General networks may function in a similar manner, or for a similar purpose, as home or business local area networks configured to provide network access to a wide array of electronic devices for general purpose computing, such as email, web-browsing, and the like. Network access point 118 may establish, or otherwise provide access to, the general network. For example, network access point 118 may be a wired or wireless router or switch device configured to receive and distribute data from and to various devices coupled with it and/or between other networks, such as network 120. After connecting to network access point 118, the various electronic devices may transmit and/or receive data via the general network. In some embodiments, a general network is defined as a network which a user explicitly authorizes devices to use for communication by providing a password and SSID, or other access credentials. In contrast, access to private networks, such as those described below, may be managed by a device such as television receiver 110, and users may be otherwise unable to directly provide access credentials to such a network.

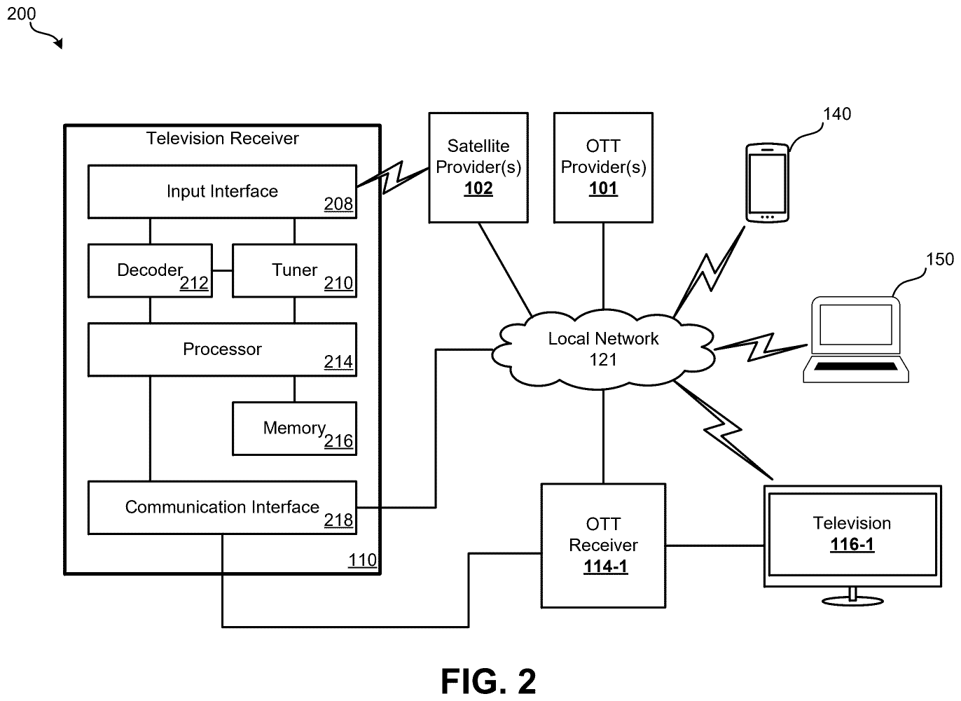

FIG. 2 illustrates an embodiment of an integrated OTT and satellite television receiver system 200. System 200 includes television receiver 110, OTT receiver 114-1, television 116-1, mobile device 140, and personal computer 150. System 200 also includes local network 121 that may facilitate bi-directional communication between television receiver 110 and any or all of OTT receiver 114-1, television 116-1, mobile device 140, and personal computer 150. As illustrated, television receiver 110 may receive live and/or recorded media content from satellite provider(s) 103, such as live television streams from regional broadcast television channels. voice command server system 103, via a satellite downlink. As further illustrated, OTT receiver 114-1, television 116-1, mobile device 140, and/or personal computer 150 may receive digital media content from OTT provider(s) 101 via local network 121.

As described above, television receiver 110 may be configured to receive an RF signal from a satellite antenna, tune to and/or decode one or more frequencies in the RF signal corresponding to local and/or regional broadcast television channels, and provide digital streams representing live media content provided by the broadcast television channels to OTT receiver 114-1, television 116-1, mobile device 140, and/or personal computer 150. Television receiver 110 may include one or more software and/or hardware components, such as input interface 208, tuner 210, decoder 212, processor 214, memory 216, and communication interface 218.

Input interface 208 may include one or more hardware connections configured to receive a wired connection from a satellite antenna. For example, input interface 208 may include a coaxial cable connector. Input interface 208 may be configured to receive down-converted RF signals from a Low-Noise Block Converter (LNB) of a satellite dish and the RF signals to tuner 210 and/or decoder 212. As described above, the RF signals may include a plurality of frequencies corresponding to television channels provided by satellite provider(s) 102. As further described above, a subset of the plurality of frequencies may correspond to local television channels provided by regional broadcast affiliates. In addition to transmitting local programming over-the-air via terrestrial antennas, regional broadcast affiliates may additionally transmit the local programming to satellite provider(s) 102 for distribution via satellite network.

Tuner 210 and decoder 212 may include one or more hardware and/or firmware components configured receive the RF signals from input interface 208 and convert them into a digital stream representing media content for a particular television channel or media title. For example, tuner 210 may include one or more RF filters configured to tune to a particular frequency and demodulate the frequency into separate analog audio and video signals representing media content. Tuner 210 may then provide the separate audio and video signals to decoder 212 for conversion into digital audio and video data. As another example, tuner 210 may convert the separate analog and video signals into digital data streams and provide them directly to processor 214 for storage and/or transmission. In some embodiments, tuner 210 may be preconfigured to tune to a limited subset of frequencies corresponding to local television channels. Limiting the available frequencies may prevent unauthorized access to other media streams included in the RF signals from satellite provider(s) 102.

In some embodiments, decoder 212 converts the filtered signals received from tuner 210 into digital data streams. Additionally, or alternatively, decoder 212 may apply various types of filters and color corrections to the signals. Decoder 212 may also extract additional data associated with the media content and/or television channel. The additional data may include vertical blanking interval (VBI) data, such as close caption, tele-text, and copy protection bits, as well as television guide data. In some embodiments, decoder 212 may be preconfigured to decode a limited set of video, audio, and/or data encoding standards, such as ATSC or DVB. Limiting the capabilities of decoder 212 in this way may prevent unauthorized access to other media content included in the RF signals from satellite provider(s) 102.

While described as having a single tuner, tuner 210 may include multiple tuners, such as 2, 4, 6, or any other suitable number of tuners configured to tune to independent frequencies at a same time. Including multiple tuners may allow television receiver 110 to process multiple media content streams at the same time. For example, a first tuner may tune to a first frequency associated with a first television channel requested by OTT receiver 114-1 while a second tuner may be tuned to a second frequency associated with a second television channel requested by personal computer 150. As another example, a first tuner may tune to a first frequency associated with a first television channel for retransmission to OTT receiver 114-1 while a second tuner may be tuned to a second frequency associated with video-on-demand (VOD) content for storage by memory 216, as described further below.

Processor 214 may include one or more processors configured to execute instructions stored in memory 216 of television receiver 110 to receive the digital data streams from tuner 210 and/or decoder 212 and provide the digital data streams to remote devices for display. In some embodiments, processor 214 pre-processes and/or compresses the digital data streams before transmitting the media content to remote devices for displace. For example, processor 214 may pre-process the digital data stream based on an input type, an output type, compression properties, and a target bit rate. After pre-processing, processor 214 may compress the audio and video to a desired bit rate using any suitable compression technique (such as WM9, MPEG-4, H.263, and H.264). The compressed audio and video may be multiplexed into a single media stream together along with other user data such as close caption, tele-text, parental control, and Macrovision. In some embodiments, processor 214 is capable of statically and/or dynamically adjusting the compression bit rate, frame rate, resolution, and filtering depending on a user request, the input content, available network bandwidth, or on any other data known to processor 214. The compressed media stream may then be converted into network packets for transmission over local network 121 or a remote network, such as the Internet, via communication interface 218.

As described above, processor 214 may also receive and process commands received from one or more client devices via communication interface 218. For example, processor 214 may receive a request from OTT receiver 214-1 for a list of available channels and/or a programming schedule. In response, processor 114 may cause tuner 210 to briefly tune to the available subset of frequencies, or to a television guide frequency, and provide the requested information to OTT receiver 214-1. As another example, processor 214 may receive a request for live television content from a local television channel from mobile device 140. In response, processor 214 may cause tuner 210 and/or decoder 212 to tune to a particular frequency corresponding to the local television channel and return a digital data stream representing the live television content from the local television channel. Additional examples of commands include changing compression properties (compression type, bit rate, frame rate, resolution, and other properties), requesting and/or accessing VOD content, and any other command that a user may desire for viewing media content.

In some embodiments, processor 214 determines at which frequencies to tune tuner 210 based on a predefined mapping of frequencies to available television channels. For example, memory 216 may include a predefined mapping of frequencies to available television channels. Additionally, or alternatively, processor 214 may request and/or receive updated mappings from a remote service provider, such as satellite provider(s) 102. For example, processor 214 may request a mapping of authorized television channels for a user account associated with television receiver 110 from satellite provider(s) 102 via local network 121. As another example, processor 214 may request a mapping of frequencies to local television channels based on a geographic region in which television receiver is located (e.g., based on an IP address for local network 121).

In some embodiments, processor 214 is further configured to store and provide VOD content. For example, processor 214 may cause tuner 210 to tune to one or more VOD frequencies to receive previously recorded media content, such as movies, television shows, music, and the like. Processor 214 may then store the previously recorded media content in memory 216 for subsequent viewing. For example, in response to a request from OTT receiver 214-1 to view a particular media title stored in memory 216, processor 214 may access the previously recorded media content and transmit it to OTT receiver 214-1 via communication interface 218.

Memory 216 may include one or more hardware and/or software components configured to store instructions for execution by processor 214, media content, television channel frequencies, and the like. Communication interface 218 may be a wireless or a wired interface, or may have provisions for both types. For example, communication interface 218 may include one or more wired outputs, such as an ethernet port, a USB port, a coaxial port, and the like. As another example, communication interface 218 may include one or more antennas configured to transmit data wirelessly. Communication interface 218 may additionally, or alternatively, include a network adaptor that enables television receiver 110 to transmit and receive data via one or more wired or wireless networks, such as local network 121.

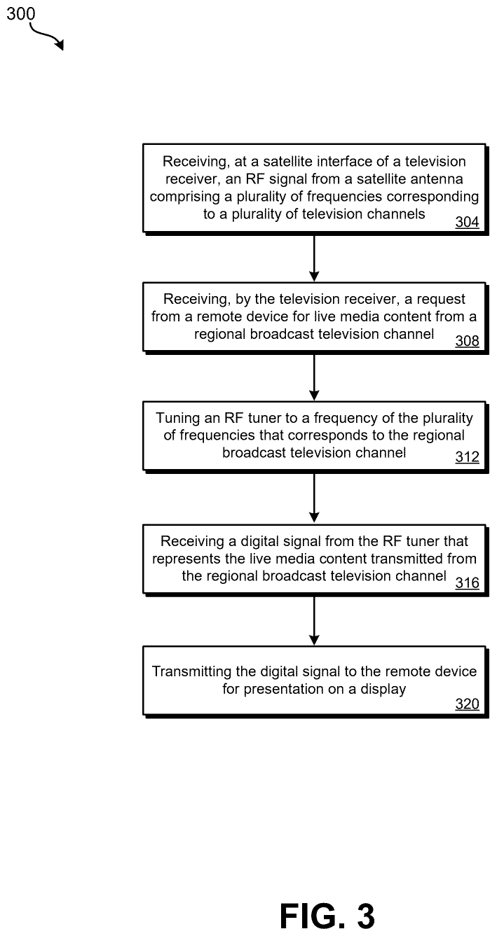

Various methods may be performed using the systems and devices detailed in FIGS. 1 and 2 to integrate satellite television into OTT devices and services. FIG. 3 illustrates an embodiment of a method 300 for integrating satellite television content and OTT services. In some embodiments, one or more blocks of method 300 may be performed by components of system 100 and system 200, such as television receiver 110. For example, the components of television receiver 110 described above may perform some or all of the steps of method 300.

Method 300 may include, at block 304, receiving an RF signal from a satellite antenna. The RF signal may be received by a satellite input interface of a television receiver, such as input interface 208 of television receiver 110 as described above. The RF signal may include individual signals at a each of a plurality of frequencies. The plurality of frequencies may correspond to a plurality of television channels and each individual signal may be encoded with media content from a corresponding television channel. The plurality of frequencies may further include a subset of frequencies corresponding to local television channels for a geographic region. For example, as described above, the subset of frequencies may correspond to television channels provided by one or more regional broadcast affiliates. Additionally, or alternatively, the RF signal may include frequencies associated with other media content, such as VOD titles (e.g., shows and movies), music, and the like.

At block 308, a tuning request for live media content from a regional broadcast television channel is received by the television receiver. The tuning request may be received via a communication interface of the television receiver and provided to a processor of the television receiver. The tuning request may be received from a remote device, such as an OTT device coupled to a display device, a smart television with OTT services installed thereon, a mobile device, a personal computer, and the like. The remote device may be communicatively connected with the television receiver via a wired or wireless connection. For example, the television receiver and the remote device may be coupled via a USB cable, a coaxial cable, or similar data transmission cable. As another example, the television receiver and the remote device may be in wireless communication with each other via one or more LAN and/or WAN connections. The tuning request may include an identification of the regional broadcast television channel, such as a station ID, local television channel number, station name, and the like.

At block 312, an RF tuner is tuned to a frequency that corresponds to the regional broadcast television channel. The RF tuner may be coupled to the satellite interface and receive tuning commands from a processor of the television receiver. For example, in response to receiving the request at block 308, the processor of the television receiver may determine the first frequency that corresponds to the regional broadcast television channel and cause the RF tuner to tune to the first frequency.

At block 316, a digital signal is received from the RF tuner. The digital signal may be received by the processor of the television receiver in response to causing the RF tuner to tune to the frequency corresponding to the regional broadcast television channel. For example, after causing the RF tuner to tune to the frequency, the RF tuner may filter the RF signal received via the satellite interface to the specified frequency and demodulate the frequency into a digital signal. The digital signal may represent live media content transmitted by the regional broadcast television channel. For example, the digital signal may include multiplexed audio and video data.

At block 320, the digital signal is transmitted to the remote device for display. As described above, the remote device may receive the digital signal from the television receiver and convert the audio and video data into any suitable format for display. The remote device may then transmit the formatted media content to a display device, such as a television or monitor, via a display cable. Alternatively, in the case of a remote device with an integrated display, the remote device may proceed to display the live media content via the integrated display. As further described above, the remote device may present the live media content integrated with content received from other sources, such as OTT providers.

Method 300 may optionally include additional blocks for switching between content from different broadcast television channels. For example, the processor of the television receiver may receive a subsequent request for live media content from a different television channel, tune the RF tuner to a new frequency corresponding to the different television channel, and begin transmitting the digital data from the new frequency to the remote device. Additionally, or alternatively, method 300 may include steps for storing media content for later playback. For example, in addition to, or instead of, transmitting the digital data to a remote device, the processor of the television receiver may store the digital data in a memory of the television receiver for later access. Subsequently, when a request for the recorded media content is received from a remote device, the processor may access the digital data in the memory and begin transmitting it to the remote device for display.

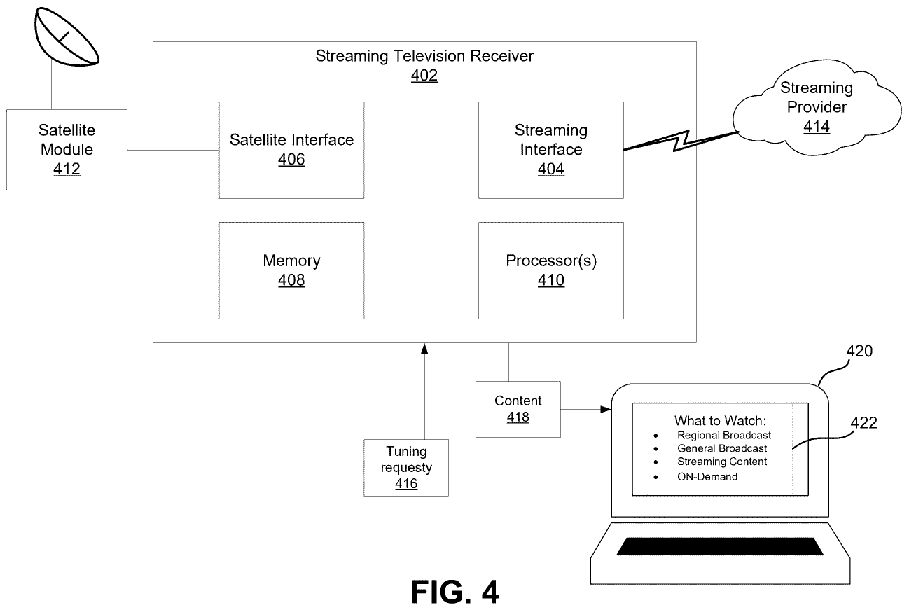

FIG. 4 illustrates a system 400 for receiving and displaying content from satellite sources and streaming providers, according to certain embodiments. The system 400 may be similar to the systems 100 and 200, described in relation to FIGS. 1 and 2, respectively. The system 400 may therefore be thought of as encompassing all or some of FIGS. 1 and 2. The system 400 may include a streaming television receiver 402, with a streaming interface 404, a satellite interface 406, a memory 408, and one or more processors (“processors”) 410. The system 400 may also include a satellite module 412 and a presentation device 420. The streaming television receiver 402 may include one or more hardware and/or software components working together and/or separately to receive and provide content to the presentation device 420. The streaming television receiver 402 may be similar to the television receiver 110 in FIG. 1, and include similar components and functionalities.

The streaming interface 404 may be configured to receive data signals (e.g., content) from one or more content providers, such as streaming provider 418. The streaming provider 418 may provide live content, on-demand content, etc., which may be offered in multiple geographical areas. Thus, the data signals received by the streaming interface 404 may correspond to a plurality of non-regional broadcast channels. For example, the a first non-regional broadcast channel may be associated with the streaming provider 418.

The streaming interface 404 may also be configured to receive instructions (e.g., from the processors 410, from the presentation device 420, etc.) to select a particular non-regional broadcast channel of the plurality of broadcast channels. Thus, the streaming interface 404 may include functionalities to communicate via TCP/IP and/or other networking interfaces in order to request and receive streaming content. In some embodiments, the streaming interface 404 may be configured to communicate with one or more digital rights management (DRM) services in order to decrypt the streaming content.

The satellite interface 406 may be configured to receive and transmit signals to and from the satellite module 412. The satellite interface 406 may be configured access an authorization table to identify broadcast channels that the presentation device is authorized to access. The authorization table may be stored in the memory 408, or may be stored remotely (e.g., a separate device, a cloud database, etc.) The authorization table may include information such as frequencies associated with various channel, account information associated with the presentation device, and other such information.

The satellite module 412 may include some or all of the components of the television receiver 110. For example, the satellite module 412 may include tuners and decoders, configured to tune a satellite dish to receive signals at a plurality of frequencies and decode the signals. At least some of the pluralities of frequencies may correspond to regional broadcast channels (i.e., channels that are geographically limited). The satellite module 412 may then transmit decoded content to the streaming television receiver 402. In some embodiments, the satellite module 412 may be incorporated in the streaming television receiver 402. In other embodiments, the satellite module 412 may be a separate device, such as a receiver, dongle, or other such device that is communicably connected to the streaming television receiver.

The streaming television receiver 402 may also be configured to generate a user interface (UI) 422 and transmit the UI 422 to the presentation device 420. The UI 422 may include an electronic programming guide. The UI 422 may therefore include listings and/or inputs that allow a user to select some or all of the regional and/or non-regional broadcast channels available to the presentation device via the streaming television receiver 402 (and/or the satellite interface 406 and the streaming interface 404). In some embodiments, the UI 422 may only display channels that are available to the streaming television receiver (e.g., channels that appear in the authorization table). In other embodiments, the UI 422 may display all channels that may be available.

The memory 408 may include instructions that, when executed by the processors 410, cause the system 400 to perform operations to receive and display content. For example, the processors 410 (or some other component of the streaming television receiver 402) may access channels that are available to the streaming television receiver 402 from the streaming interface 404 and/or the satellite interface 406. Then, the streaming television receiver 402 may transmit data to the presentation device 420 such that the UI 422 is displayed on the presentation device 420. As seen in FIG. 4, the UI 422 may include a regional broadcast, a general broadcast (i.e., non-regional broadcast), streaming content, and on-demand content. The UI 422 in FIG. 4 is merely an example, any number of channels and channel types (e.g., multiple regional and/or non-regional channels) may be included in the UI 422.

In response to an input (e.g., a user selection), the presentation device 420 may transmit tuning request 416 to the streaming television receiver 402. The tuning request 416 may be received by an input module (not shown) or some other component of the streaming television receiver 402. The tuning request 416 may then be parsed to identify a channel and/or an interface associated with the tuning request 416. For example, the tuning request 416 may indicate a non-regional broadcast available from an online streaming service. The tuning request 416 may then be transmitted to the streaming interface 404. In another example, the tuning request 416 may indicate that a regional broadcast channel. Then, the tuning request 416 may be transmitted to the satellite interface 406. Some or all of the tuning request 416 may then be transmitted to the satellite module 412 as tuning instructions. The tuning instructions may cause the satellite module to adjust one or more RF tuners in order to receive the indicate regional broadcast channel.

The satellite module 412 may then receive the regional broadcast channel according to the tuning instructions. Data associated with the regional broadcast channel may or may not be encrypted. In some embodiments, the satellite module 412 may include a conditional access module. The conditional access module may be configured to determine whether the presentation device (or user thereof) is permitted to access the regional broadcast channel. For example, the regional broadcast channel may correspond to a different geographic location than the physical location of the presentation device. Then, the satellite module 412 may not decrypt the regional broadcast channel (or data thereof). Other conditional access thresholds may include account level/type, age, parental controls, etc.

The satellite module 412 may transmit the data (i.e., content) of the regional broadcast channel to the satellite interface 406. The satellite interface 406 and/or the streaming television receiver 402 may then output the data to the presentation device 420 for display.

In some embodiments, the streaming television receiver 402 may cause the satellite module 412 to determine which channels are available via satellite. For example, the satellite module 412 may receive any number of RF frequencies transmitted via a satellite orbiting the earth. Each of the RF frequencies may include any number of television channels encoded and transmitted via the RF frequency. The streaming television receiver 402 may then transmit instruction to the satellite module to scan the plurality of RF frequencies to identify a plurality television channels available via the RF frequencies. The satellite module 412 may then transmit a list indicating the available channels to the streaming television receiver 402.

The streaming television receiver 402 may then utilize the authorization table (e.g., included in the memory 408) to identify a plurality of regional broadcast channels that the presentation device (or a user thereof) is authorized to access. For example, the satellite module 412 may receive television channels from a first geographical area and a second geographical area (as satellite transmissions may be relatively indiscriminate). The presentation device 420, however, may only be authorized to access regional broadcast television channels from the first geographical area. Thus, when the streaming television receiver 402 checks the list of channels encoded in the plurality of RF signals against the authorization table, the streaming television receiver 402 may identify the regional channels that the presentation device 420 is permitted to access (and/or other channels the presentation device 420 may be permitted to access). The streaming television receiver 402 may then generate the UI 422 to include the plurality of regional broadcast channels authorized for the presentation device 420.

At some point, the streaming television receiver 402 may receive a second request from the presentation device 420 (e.g., via a second input from the UI 422). The second request may indicate a non-regional broadcast television channel (from one of the streaming interface or the satellite interface). The streaming television receiver 402 may then transmit some or all of the request to the streaming provider 414 via the streaming interface 404. Once the streaming interface 404 receives content associated with the requested non-regional broadcast television channel, The streaming television receiver 402 may transmit the content to the presentation device 420 for display.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A television media broadcaster comprising:
a satellite antenna interface for receiving a radio frequency (RF) signal from a satellite antenna, wherein the RF signal comprises a plurality of frequencies corresponding to a plurality of television channels, and the plurality of frequencies comprises a subset of frequencies that correspond to regional broadcast television channels;
an RF tuner coupled to the satellite antenna interface, wherein the RF tuner is configured to filter the RF signal to the subset of frequencies and demodulate the filtered frequencies into digital signals;
a communication interface configured to transmit the digital signals to a remote device for presentation on a display;
a memory storing a set of instructions; and
a processor coupled to the RF tuner, the communication interface, and the memory, the processor being configured to execute the set of instructions to:
receive, via the communication interface, a tuning request from the remote device for live media content from a first regional broadcast television channel;
tune the RF tuner to a first frequency of the subset of frequencies that corresponds to the first regional broadcast television channel;
receive, in response to tuning the RF tuner, a digital signal from the RF tuner representing the live media content transmitted from the first regional broadcast television channel; and
transmit, via the communication interface, the digital signal to the remote device for presentation on the display.

2. The television media broadcaster of claim 1, wherein the communication interface comprises a network adaptor, the request from the remote device comprises a unique address for the remote device, and transmitting the digital signal to the remote device comprises transmitting the digital signal to the unique address for the remote device over a network.

3. The television media broadcaster of claim 2, wherein the network is a local area network.

4. The television media broadcaster of claim 2, wherein the network comprises a wide area network.

5. The television media broadcaster of claim 2, further comprising a wireless network antenna coupled to the network adaptor.

6. The television media broadcaster of claim 1, further comprising a wired communication port coupled to the communication interface and configured to receive a wired connection to the remote device.

7. The television media broadcaster of claim 6, wherein the wired communication port comprises a coaxial cable port.

8. The television media broadcaster of claim 1, wherein the RF signal further comprises a video-on-demand (VOD) frequency and the processor is further configured to execute the set of instructions to:
receive a recording request for recorded media content from a satellite based content provider;
tune the RF tuner to the VOD frequency; and
receive, in response to tuning the RF tuner to the VOD frequency, a second digital signal representing the recorded media content transmitted from the satellite based content provider.

9. The television media broadcaster of claim 8, wherein the processor is further configured to execute the set of instructions to:
store the recorded media content from the second digital signal in the memory;
receive, via the communication interface, a playback request from the remote device for the recorded media content; and
transmit the recorded media content from the memory as a third digital signal to the remote device for presentation on the display.

10. The television media broadcaster of claim 8, wherein the processor is further configured to execute the set of instructions to:
transmit, via the communication interface, the second digital signal to the remote device for storage by the remote device.

11. The television media broadcaster of claim 1, wherein the RF tuner is a first RF tuner, the television media broadcaster further comprises a second RF tuner coupled to the satellite antenna interface, and the processor is further configured to execute the set of instructions to:
receive, via the communication interface, a second tuning request from a second remote device for second live media content from a second regional broadcast television channel;
determine that the first RF tuner is allocated to the first frequency;
tune the second RF tuner to a second frequency of the subset of frequencies that corresponds to the second regional broadcast television channel;
receive a second digital signal from the second RF tuner representing the second live media content; and
transmit, via the communication interface, the second digital signal to the second remote device while concurrently transmitting the digital signal from the first RF tuner to the remote device.

12. The television media broadcaster of claim 1, wherein the processor is further configured to execute the set of instructions to:
receive, via the communication interface, an indication of a geographic region within which the television media broadcaster is located; and
determine, based on the indication of the geographic region, the subset of frequencies that correspond to the regional broadcast television channels for the geographic region.

13. The television media broadcaster of claim 1, wherein the processor is further configured to execute the set of instructions to:
receive, via the communication interface, user account information;
transmit, via the communication interface, an authentication request to a satellite service provider server system, wherein the authentication request comprises the user account information; and
receive, via the communication interface, an authentication response from the satellite service provider server system, wherein the authentication request comprises the subset of frequencies that correspond to the regional broadcast television channels.

14. A system, comprising:
a satellite module communicably coupled to a satellite antenna, the satellite module receiving a radio frequency (RF) signal from the satellite antenna, wherein the RF signal comprises a plurality of frequencies corresponding to a plurality of television channels, the satellite module configured to tune a first regional broadcast television channel from the plurality of frequencies; and
a streaming television receiver comprising:
a streaming interface configured to receive a plurality of non-regional broadcast television channels from a streaming provider;
a satellite interface to communicably couple to the satellite module;
a memory storing a set of computer-readable instructions;
a processor coupled to the satellite interface, the memory and the satellite interface, the processor being configured to execute the set of instructions to:
present a user interface for the streaming provider, the user interface presenting an electronic programming guide comprising the first regional broadcast channel and the non-regional broadcast television channels;
receive a request for content from the first regional broadcast television channel;
instruct the satellite module to tune to the first regional broadcast television channel;
receive the content from the satellite module; and
output the content for presentation by a presentation device.

15. The system of claim 14, wherein the processor is further configured to:
instruct the satellite module to scan the plurality of frequencies and identify a plurality of television channels available in the RF signal; and
utilize an authorization table to identify a plurality of regional broadcast television channels authorized for reception by the streaming television receiver; and
responsive to identifying the plurality of regional broadcast television channels are authorized for reception by the streaming television receiver, generating the electronic programming guide including the plurality of regional broadcast television channels.

16. The system of claim 14, wherein the satellite module comprises a dongle that communicatively couples to the television receiver.

17. The system of claim 14, wherein the satellite module further comprises a conditional access module to decrypt the content for the first regional broadcast television channel.

18. The system of claim 14, wherein the processor is further configured to:
receive a second request for second content associated with a first non-regional broadcast television channel of the plurality of non-regional broadcast television channels;
transmit a request to the streaming provider for the second content through the streaming interface;
receive the second content via the streaming interface; and
output the second content for presentation by a presentation device.

19. A streaming television receiver, comprising:
a satellite module configured to receive a radio frequency (RF) signal from a satellite antenna, wherein the RF signal comprises a plurality of frequencies corresponding to a plurality of television channels, the satellite module configured to tune a selected broadcast television channel of the plurality of satellite television channels from the plurality of frequencies;
a streaming interface configured to receive a plurality of non-satellite broadcast television channels from a streaming provider through via the Internet;
a memory storing a set of instructions;
an authorization table identifying the selected broadcast television channel that the streaming television receiver is authorized to access; and
a processor coupled to the streaming interface, the memory and the satellite module, the processor being configured to execute the set of instructions to:
receive a user input identifying the selected broadcast television channel;
identify whether the selected broadcast television channel is broadcast in the plurality of satellite television channels or the plurality of non-satellite broadcast television channels;
determining whether the streaming television receiver is authorized to access the selected broadcast television channel based on the authorization table;
responsive to identifying that the selected broadcast television channel is broadcast within the plurality of satellite television channels, instructing the satellite module to tune the selected broadcast television channel; and
output the content from the selected television broadcast channel for presentation by a presentation device.

20. The system of claim 19, wherein the processor is further configured to:
receive a second request for second content associated with a first non-regional broadcast television channel of the plurality of non-regional broadcast television channels;
transmit a request to the streaming provide for the second content through the communication interface;
receive the second content via the communication interface; and
output the second content for presentation by a presentation device.
